(19) United States
(12) Patent Application Publication
(10) Pub. No.: US 2019/0225545 A1
(43) Pub. Date: Jul. 25, 2019

(54) CALCINED KAOLIN AS EXTENDER FOR COATINGS

(71) Applicant: BASF Corporation, Flortham Park, NJ (US)

(72) Inventors: Ismail Yildirim, Milledgeville, GA (US); Ashok Khokhani, Manalapan, NJ (US); Danny Williams, Macon, GA (US); Bryan Mudd, Gastonia, NC (US)

(21) Appl. No.: 16/254,217

(22) Filed: Jan. 22, 2019

Related U.S. Application Data
(60) Provisional application No. 62/619,548, filed on Jan. 19, 2018.

(51) Int. Cl. C04B 33/04; C04B 33/02; C04B 33/13; C04B 33/32; C04B 35/622

(52) U.S. Cl. CPC C04B 33/04; C04B 33/025; C04B 33/13; C04B 33/32; C04B 2235/74; C04B 2235/349; C04B 2235/5472; C04B 2235/5436; C04B 2235/9661; C04B 35/62222

(57) ABSTRACT

Calcined kaolin comprising a narrow particle size distribution and a fluxing agent are disclosed herein. In some examples, the calcined kaolin comprises particles, wherein 90% by weight or less of the particles have a diameter of less than 10 microns; 80% by weight or less of the particles have a diameter of less than 5 microns; 40% by weight or less of the particles have a diameter of less than 2 microns; and 20% by weight or less of the particles have a diameter of less than 1 micron. The calcined kaolin exhibits improved brightness, whiteness, particle size distribution, mullite index, and +325 mesh residue level compared to conventional calcined kaolin. Methods of making and using the calcined kaolin particles are also provided herein.

### CROSS-REFERENCE TO RELATED APPLICATIONS

This application claims the benefit of and priority to U.S. Provisional Application No. 62/619,548 filed on Jan. 19, 2018, the disclosure of which is expressly incorporated herein by reference in its entirety.

### FIELD OF THE DISCLOSURE

This disclosure relates generally to calcined kaolins for use as, for example, a paint extender.

### BACKGROUND OF THE DISCLOSURE

Calcined kaolin has traditionally found use in interior higher pigment volume concentration (PVC) flat and eggshell paints. Generally, the calcined kaolin functions as an opacifier and thus, extend more expensive pigments such as titanium dioxide as well as provide a flatting (or matting) effect. More specifically, calcined kaolin, as an extender, can help to achieve desired hiding power, tint strength, color, and gloss and sheen of a final, dried paint film. Calcined kaolin can also impart opacity, whiteness, and other desirable properties.

Recently, considerable efforts have been made to develop calcined kaolin pigment extenders to provide scrub, burnish, and stain resistance. These pigment extenders are produced by fully calcining a fine particle size fraction of hydrous kaolin in the presence of a fluxing agent to promote particle aggregation during calcination step. Products supplied under the trademarks Mattex® and Mattex PRO by BASF Corporation are exemplary calcined kaolin pigment extenders and have been shown to provide scrub and burnish resistance as well as improved optical properties, compared to other pigment extenders known in the art.

Generally, the properties of calcined kaolin pigments are dependent on a number of pigment related attributes. These attributes include brightness, whiteness, particle size distribution (PSD) or average particle size, mullite index (M.I.), residue level, and the texture of the individual particles or of agglomerates thereof. However, the typical calcined kaolins have a significantly broad particle size distribution and do not provide necessary scrub, burnish and stain resistance alongside desired optical properties such as whiteness, brightness, tint strength, gloss and sheen on the paint film.

A need exists for compositions and methods for producing fully calcined kaolin pigments capable of providing one or more improved physical properties, for example, opacity, brightness, whiteness, and gloss/sheen control in paints while at the same time improving scrub and burnish resistance. The materials and methods disclosed herein address these and other needs.

### SUMMARY OF THE DISCLOSURE

Calcined kaolin comprising a fluxing agent are disclosed herein. The calcined kaolin exhibits several desirable pigment attributes including improved brightness, whiteness, particle size distribution, mullite index, and +325 mesh residue level. In some embodiments, the calcined kaolin exhibits a GE brightness of 90 or greater (e.g., 92 or greater, from 90 to 96, or from 92 to 96) and a mullite index of 35 or greater (e.g., 45 or greater or from 35 to 65). The +325 mesh residue content of the calcined kaolin can be less than 0.2% by weight (e.g. less than 0.15% by weight, from 0.01% to 0.15% by weight, or from 0.01% to 0.10% by weight) of the calcined kaolin.

The calcined kaolin disclosed herein have a narrow particle size distribution, as measured by a Sedigraph 5100 Particle Size Analyzer. In certain embodiments, the calcined kaolin comprises particles, wherein 90% by weight or less (such as 89% or less or 79% or less) of the particles have a diameter of less than 10 microns; 80% by weight or less (such as 72% or less, 64% or less, or 54% or less) of the particles have a diameter of less than 5 microns; 40% by weight or less (such as 28% or less or 24% or less) of the particles have a diameter of less than 2 microns; and 20% by weight or less (such as 16% or less, 11% or less, or 9% or less) of the particles have a diameter of less than 1 micron. In some examples, the calcined kaolin can have a particle size distribution wherein 75% by weight or less of the particles have a diameter of less than 10 microns; 60% by weight or less of the particles have a diameter of less than 5 microns; 35% by weight or less of the particles have a diameter of less than 2 microns; and 15% by weight or less of the particles have a diameter of less than 1 micron. The average particle size of the calcined kaolin particles can be 2.5 microns or greater (e.g., 3.5 microns or greater, from 2.5 to 15 microns, from 2.9 to 15 microns, from 3.5 to 15 microns, or from 3.5 to 10 microns).

As described above, the calcined kaolin include a fluxing agent. Fluxing agents can be utilized to lower the calcination temperature needed to obtain the desirable properties of the calcined kaolin particles. The fluxing agent can include an alkali earth metal salt, an alkaline earth metal salt, or a combination thereof. Specific examples of fluxing agents include borax, soda ash, potassium hydroxide, potassium phosphate such as potassium tripolyphosphate, potassium silicate, caustic soda, sodium hexametaphosphate, sodium polyacrylate, sodium silicate, or a combination thereof. The fluxing agent can be present in an amount of less than 2.5% by weight, for example, from 1.5% to less than 2.5% or from 1.5% to less than 2% by weight of the calcined kaolin.

The average surface area of the calcined kaolin particles can be at least 2 m²/g, as determined by Micromeritics Gemini 2370 surface area analyzer. For example, the calcined kaolin particles can have an average surface area of less 10 m²/g, 2 m²/g or greater, from 2 m²/g to 10 m²/g, from 3 m²/g to 10 m²/g, from 4 m²/g to 10 m²/g, from 3 m²/g to 6 m²/g, as determined by Micromeritics Gemini 2370 surface area analyzer. The calcined kaolin particles can exhibit an oil absorption of from 65% by weight or less, 60% by weight or less, 55% by weight or less, or 45% by weight or less, such as from 25% to 65% by weight, from 35% to 65% by weight, from 25% to 55% by weight, or from 25% to 45% by weight. The Hunter yellowness index of the calcined kaolin particles can be 3.0 or less, for example, from 2.0 to 3.0, as determined by Technibrite Micro TB-1C brightness meter.

Methods of making and using the calcined kaolin particles are also provided herein. The methods can include processing a coarse kaolin crude having a median particle size diameter (d50) of at least 0.40 microns, as measured by a Sedigraph 5100 Particle Size

Analyzer, to form the calcined kaolin particles. Specifically, the method can include optionally blending the coarse kaolin crude with a fine kaolin in a weight ratio of from 1:1 to 20:1 (such as from 2:1 to 20:1, from 1:1 to 10:1, from 1:1 to 5:1, from 1:1 to 3:1 or from 3:1 to 5:1) to form a blend; surface treating the coarse kaolin or the blend with a fluxing agent to obtain a treated kaolin, calcining the treated kaolin to obtain a calcined kaolin; and refining the calcined kaolin to obtain the calcined kaolin particles. In some examples, 60% by weight or greater of particles in the coarse kaolin or the blend have a particle size of less than 2 microns, as measured by a Sedigraph 5100 Particle Size Analyzer. The method of making the calcined kaolin particles can comprise refining the coarse kaolin crude using a method selected from degritting, centrifugation, flotation, selective flocculation, magnetic purification, bleaching, delamination with for example media grinders, pulverizing, or a combination thereof. Refining the coarse kaolin crude can be performed prior to surface treating the coarse kaolin crude or the blend with a fluxing agent.

The coarse kaolin crude, from which the calcined kaolin particles can be derived, have a particle size distribution wherein 99% by weight or greater of the particles have a diameter of less than 10 microns; 96% by weight or greater of the particles have a diameter of less than 5 microns; 81% by weight or greater of the particles have a diameter of less than 2 microns; and 48% by weight or greater of the particles have a diameter of less than 0.5 microns. The coarse kaolin crude can have a median particle size diameter of 0.55 microns or greater. In some embodiments, the calcined kaolin particles can be derived from a coarse kaolin crude comprising 50% to 70% by weight of particles having a diameter of less than 2 microns. The optional blend of coarse kaolin crude and fine kaolin, from which the calcined kaolin particles can be derived, have a particle size distribution wherein, 99% by weight or greater of the particles have a diameter of less than 10 microns; 97% by weight or greater of the particles have a diameter of less than 5 microns; 85% by weight or greater of the particles have a diameter of less than 2 microns; and 55% by weight or greater of the particles have a diameter of less than 0.5 microns. The blend can have a median particle size diameter of 0.48 microns or greater.

The calcined kaolin obtained after calcination can be pulverized and/or further classified, for example, via an air cyclone, an air sifter, or combinations thereof to obtain a coarse calcined kaolin and a fine calcined kaolin. The fine calcined kaolin particles can have lower levels of +325 mesh residue level and crystalline silica content than the coarse calcined kaolin. The coarse calcined kaolin can have a +325 mesh residue level of from 0.5% to 5% by weight and a crystalline silica content of 0.5% by weight or less.

Compositions comprising the calcined kaolin particles are disclosed herein. In some embodiments, the calcined kaolin particles can be formulated as a coating formulation, such as a paint, for example, a flat paint. Application of the coating formulation, for example as a paint, to a substrate can, in some instances, provide a scrub resistance of at least 1400 cycles (e.g., at least 1800 cycles, or from 1400 cycles to 2200 cycles) as determined by ASTM D2486-06, after curing. In some embodiments, the cured formulations can exhibit an initial (unscrubbed) gloss at 85° of less than 3 and an increase in gloss at 85° of no more than 5 gloss units after scrubbing, as determined by ASTM D2457 using a BYK micro-tri-gloss meter. In some embodiments, the cured formulations can exhibit an improved brightness (e.g., 2% or less, such as from 1.0 to 1.7% increase in brightness), compared to an identical formulation comprising calcined kaolin having a particle size steepness of 20. In some embodiments, the cured formulations can exhibit an improved whiteness (e.g., 3% or less, such as from 1.5 to 3% increase in whiteness), compared to an identical formulation comprising calcined kaolin having a particle size steepness of 20. In some embodiments, the cured formulations can exhibit a decreased yellowness (e.g., 30% or less, such as from 15% to 30% decrease in yellowness), compared to an identical formulation comprising calcined kaolin having a particle size steepness of 20. In some embodiments, the cured formulations can exhibit a decreased sheen at 85 degrees (e.g., 20% or less, such as from 5% to 20% decrease in sheen at 85 degrees), compared to an identical formulation comprising calcined kaolin having a particle size steepness of 20. The steepness of the calcined particles disclosed herein is 21 or greater, such as in the range from 21 to 38, whereas the steepness of a control sample is 20. The steepness of the particles (particle size steepness) is obtained from the Sedigraph measurements using the equation (d30*100/d70).

Additional advantages of the particles, compositions, and methods disclosed herein will be set forth in part in the description that follows or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

The accompanying drawing, which is incorporated in and constitute a part of this specification, illustrates an embodiment of the disclosure and together with the description, serve to explain the principles of the disclosure.

FIG. 1 is a process flow diagram showing preparation of calcined kaolin pigments.

### DETAILED DESCRIPTION

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments and are also disclosed. As used in this disclosure and in the appended claims, the singular forms “a”, “an”, “the”, include plural referents unless the context clearly dictates otherwise. The disclosure of percentage ranges and other ranges herein includes the disclosure of the endpoints of the range and any integers provided in the range.

Provided herein are calcined kaolin particles exhibiting high brightness, coarse particle size, and narrower particle size distribution compared to conventional calcined kaolin products. The calcined kaolin particles can be advantageously used in paints as a pigment extender to improve its optical properties such as brightness, whiteness, opacity and gloss/sheen control, and at the same time provide superior scrub and burnish resistance of the paints compared to conventional calcined kaolin products. In some instances, the unique properties of the calcined kaolin particles can be obtained by calcining a specific selection of hydrous kaolin in the presence of reduced amounts of flux(es) compared to the amounts generally used in the field.

The calcined kaolin particles disclosed herein can have a coarse or granular particle size distribution. Particle size distribution (PSD) as used herein can be determined with the SEDIGRAPH 5100 particle size analyzer (Micromeritics Corporation) on kaolin particles in a fully dispersed condition in a standard aqueous medium, such as water. Alternatively, a Microtrac Model 53500 Particle Size Analyzer can be used to provide comparable results. The data are reported as equivalent spherical diameters (e.s.d.) on a weight percentage basis. The median particle size d50 is the value determined in this way of the particle e.s.d. at which there are 50% by weight of the particles that have an e.s.d. less than or equal to the d50 value and 50% by weight of the particles that have an e.s.d. greater than or equal to the d50 value.

The calcined kaolin particles can have a median particle size distribution wherein 50% (d₅₀) by weight of the particles have a diameter (e.s.d.) of 2.5 μm or greater, 2.6 μm or greater, 2.7 μm or greater, 2.8 μm or greater, 2.9 μm or greater, 3.0 μm or greater, 3.2 μm or greater, 3.5 μm or greater, 4.0 μm or greater, 4.5 μm or greater, 5.0 μm or greater, or 6.0 μm or greater, as determined by a Sedigraph 5100 particle size analyzer. In some embodiments, the calcined kaolin particles can have a median particle size distribution wherein 50% (d₅₀) by weight of the calcined kaolin particles have a diameter of 15 μm or less, 14 μm or less, 13 μm or less, 12 μm or less, 11 μm or less, 10 μm or less, 9.0 μm or less, 8.0 μm or less, 7.0 μm or less, 6.0 μm or less, 5.5 μm or less, or 5.0 μm or less, as determined by a Sedigraph 5100 particle size analyzer. In some embodiments, the calcined kaolin particles can have a median particle size distribution wherein 50% (d₅₀) by weight of the calcined kaolin particles have a diameter of from 2.5 μm to 15 μm, from 2.6 μm to 15 μm, from 2.7 μm to 15 μm, from 2.8 μm to 15 μm, from 2.9 μm to 15 μm, from 3.0 μm to 15 μm, from 3.2 μm to 15 μm, from 3.5 μm to 15 μm, from 2.5 μm to 10 μm, or from 2.9 μm to 10 μm, as determined by a Sedigraph 5100 particle size analyzer.

The calcined kaolin particles can have a median particle size distribution wherein 50% (d₅₀) by weight of the particles have a diameter (e.s.d.) of 2.5 μm or greater, 2.6 μm or greater, 2.7 μm or greater, 2.8 μm or greater, 2.9 μm or greater, 3.0 μm or greater, 3.2 μm or greater, 3.5 μm or greater, 4.0 μm or greater, 4.5 μm or greater, 5.0 μm or greater, 6.0 μm or greater, 6.5 μm or greater, 7.0 μm or greater, 7.5 μm or greater, or 8.0 μm or greater, as determined by a Microtrac Model S3500particle size analyzer. In some embodiments, the calcined kaolin particles can have a median particle size distribution wherein 50% (d₅₀) by weight of the calcined kaolin particles have a diameter of 15 μm or less, 14 μm or less, 13 μm or less, 12 μm or less, 11 μm or less, 10 μm or less, 9.0 μm or less, 8.0 μm or less, 7.0 μm or less, 6.0 μm or less, 5.5 μm or less, or 5.0 μm or less, as determined by a Microtrac Model S3500 particle size analyzer. In some embodiments, the calcined kaolin particles can have a median particle size distribution wherein 50% (d₅₀) by weight of the calcined kaolin particles have a diameter of from 2.5 μm to 15 μm, from 2.6 μm to 15 μm, from 2.7 μm to 15 μm, from 2.8 μm to 15 μm, from 2.9 μm to 15 μm, from 3.0 μm to 15 μm, from 3.2 μm to 15 μm, from 3.5 μm to 15 μm, from 2.5 μm to 10 μm, or from 2.9 μm to 10 μm, as determined by a Microtrac Model S3500particle size analyzer.

The calcined kaolin particles can have a particle size distribution wherein 90% (d₉₀) by weight of the particles have a diameter (e.s.d.) of 20 μm or less, 19 μm or less, 18 μm or less, 17.5 μm or less, 17 μm or less, 16 μm or less, 15 μm or less, 14 μm or less, or 13 μm or less, as determined by a Microtrac Model S3500 particle size analyzer. For example, the calcined kaolin particles can have a particle size distribution wherein 90% (d₉₀) by weight of the particles have a diameter (e.s.d.) of from 10 to 25 μm, from 10 to 20 μm, or from 13 to 20 μm, as determined by a Microtrac Model S3500 particle size analyzer. The calcined kaolin particles can have a particle size distribution wherein 10% (d₁₀) by weight of the particles have a diameter (e.s.d.) of 3μm or less, 2.8 μm or less, 2.6 μm or less, 2.5 μm or less, 2.4 μm or less, 2.2 μm or less, 2.0 μm or less, or 1.8 μm or less, as determined by a Microtrac Model S3500 particle size analyzer. For example, the calcined kaolin particles can have a particle size distribution wherein 10% (d₁₀) by weight of the particles have a diameter (e.s.d.) of from 1 to 5 μm, from 1.5 to 5 μm, or from 1.5 to 3 μm, as determined by a Microtrac Model S3500 particle size analyzer.

In some embodiments, the calcined kaolin particles can have an average particle size of 2.0 μm or greater, 2.3 μm or greater, 2.5 μm or greater, such as 2.6 μm or greater, 2.7 μm or greater, 2.8 μm or greater, 2.9 μm or greater, 3.0 μm or greater, 3.2 μm or greater, 3.5 μm or greater, 4.0 μm or greater, 4.5 μm or greater, 5.0 μm or greater, or 6.0 μm or greater, as determined by a Sedigraph 5100 particle size analyzer. In some embodiments, the calcined kaolin particles can have an average particle size of 15 μm or less, 14 μm or less, 13 μm or less, 12 μm or less, 11 μm or less, 10 μm or less, 9.0 μm or less, 8.0 μm or less, 7.0 μm or less, 6.0 μm or less, 5.5 μm or less, 5.0 μm or less, 4.5 μm or less, 4.0 μm or less, 3.5 μm or less, or 3.0 μm or less, as determined by a Sedigraph 5100 particle size analyzer. In some embodiments, the calcined kaolin particles have an average particle size of from 2.0 μm to 15 μm, from 2.5 μm to 15 μm, from 2.6 μm to 15 μm, from 2.7 μm to 15 μm, from 2.8 μm to 15 μm, from 2.9 μm to 15 μm, from 3.0 μm to 15 μm, from 3.2 μm to 15 μm, from 3.5 μm to 15 μm, from 2.0 μm to 10 μm, from 2.5 μm to 10 μm, or from 2.9 μm to 10 μm, from 2.0 μm to 6 μm, from 2.5 μm to 6 μm, or from 2.5 μm to 5 μm, as determined by a Sedigraph 5100 particle size analyzer.

In some embodiments, the calcined kaolin particles can comprise a particle size distribution wherein 75% by weight or greater (such as 77% or greater, 80% or greater, 82% or greater, 84% or greater, 85% or greater, 87% or greater, 89% or greater, or 90% or greater) of the particles have a diameter of less than 10 μm; 59% by weight or greater (such as 60% or greater, 62% or greater, 64% or greater, 65% or greater, 67% or greater, 70% or greater, 72% or greater, 74% or greater, 75% or greater, 77% or greater, or 80% or greater) of the particles have a diameter of less than 5 μm; 35% by weight or greater (such as 36% or greater, 37% or greater, 38% or greater, 39% or greater, or 40% or greater) of the particles have a diameter of less than 2 μm; 15% by weight or greater (such as 16% or greater, 17% or greater, 18% or greater, 19% or greater, or 20% or greater) of the particles have a diameter of less than 1 μm. In some embodiments, the calcined kaolin particles can comprise a particle size distribution wherein 90% by weight or less (such as 89% or less, 87% or less, 85% or less, 84% or less, 83% or less, 82% or less, 80% or less, 79% or less, 78% or less, or 75% or less) of the particles have a diameter of less than 10 μm; 80% by weight or less (such as 78% or less, 75% or less, 72% or less, 71% or less, 70% or less, 68% or less, 65% or less, 64% or less, 62% or less, 60% or less, 59% or less, 55% or less, or 54% or less) of the particles have a diameter of less than 5 μm; 40% by weight or less (such as 39% or less, 38% or less, 35% or less, 32% or less, 30% or less, 28% or less, 25% or less, or 24% or less) of the particles have a diameter of less than 2 μm; 20% by weight or less (such as 19% or less, 18% or less, 17% or less, 16% or less, 15% or less, 12% or less, 11% or less, 10% or less, or 9% or less) of the particles have a diameter of less than 1 μm. The particle size distribution is determined using a Sedigraph 5100 particle size analyzer.

Representative ranges for PSD and mean particle size for the calcined kaolin particles disclosed herein are provided in Table 1A.

TABLE 1A

| Calcined kaolin | Ranges | | | |
|---|---|---|---|---|
| % < 10.0 μm | 75-90 | 75-95 | 75-89 | 75-85 |
| % < 5.0 μm | 54-80 | 55-85 | 59-80 | 55-65 |
| % < 2.0 μm | 24-40 | 30-50 | 35-45 | 30-40 |
| % < 1.0 μm | 9-16 | 10-30 | 15-30 | 10-20 |
| Average | ≥2.6 | ≥2.5 | 2.5-15 | 2.9-15 |
| particle size, | | | | |
| μm | | | | |

The calcined kaolin particles disclosed herein can have a GE brightness (GEB) of at least 90%. For example, the calcined kaolin particles can have a brightness of 91% or greater, 92% or greater, 93% or greater, 94% or greater, 95% or greater, 96% or greater, or 97% or greater. In some embodiments, the calcined kaolin particles can have a brightness of from 90% to 96%, from 92% to 96%, from 93% to 96%, or from 94% to 97%. As used herein, brightness is determined by the TAPPI standard method T452. The data are reported as the percentage reflectance to light of a 457 nm wavelength (GEB value).

The calcined kaolin particles can be processed to achieve a product mullite index (M.I.) of 25% or greater. In some embodiments, the particles can be processed to achieve a product M.I. of 30% or greater, 31% or greater, 32% or greater, 35% or greater, 37% or greater, 40% or greater, 45% or greater, 50% or greater, or 55% or greater, 60% or greater, 62% or greater, or 65 or greater. In some embodiments, the particles can be processed to achieve a product M.I. of 65% or less, 62% or less, 60% or less, 55% or less, 50% or less, 45% or less, 40% or less, 35% or less, or 30% or less. In some embodiments, the particles can be processed to achieve a product M.I. of from 25% to 65%, from 30% to 65%, from 35% to 65%, from 40% to 65%, or from 45% to 65%. It is noted that flux addition will affect the processing conditions and mullite index.

The calcined kaolin particles can also be characterized based on their mesh residue content. In some embodiments, the calcined kaolin particles can have a +325 mesh residue content of less than 1% by weight of the calcined kaolin particles. For example, the calcined kaolin particles can have a +325 mesh residue content of 0.20% or less, 0.15% or less, 0.10% or less, 0.09% or less, 0.08% or less, 0.05% or less, 0.02% or less, or 0.01% or less, by weight of the calcined kaolin particles. In some embodiments, the calcined kaolin particles can have a +325 mesh residue content of from 0.01% to 0.20% from 0.05% to less than 0.20%, from 0.01% to 0.15%, or from 0.03% to 0.10% by weight of the calcined kaolin particles.

As described herein, the calcined kaolin particles can include a fluxing agent. Fluxing agents can be utilized to lower the calcination temperature needed to obtain desirable properties, such as mullite index and residue content of the calcined kaolin particles. The dosage of fluxing agent and the type of fluxing agent used are dependent on the hydrous kaolin feed morphology and its particle size distribution. A range of fluxing agents can be utilized in preparing the disclosed calcined kaolin particles. These include alkali and alkaline metal ion salts of metal oxides, carbonates or their combinations. Typical metal oxides are boron oxides, silicates, alkali and alkaline earth oxides, germanates, phosphates, alumina, antimony oxide, lead oxide, zinc oxide, arsenic oxide and zirconate. Also included is boric acid. Typical carbonates are alkali and alkaline earth carbonates such as sodium carbonate, sodium bicarbonate, calcium carbonate and magnesium carbonate. Also included are organic and inorganic non-oxide salts of alkali or alkaline earth metals capable of forming metal oxides on exposure to air at calcination temperatures including halides, nitrates, acetates, hydroxides, sulfates and organic polyelectrolytes such as a sodium salt of polyacrylic acid. Preferred fluxing agents are alkali and alkaline earths of boron oxides, silicates, phosphates, alkali and alkaline earth metal salts of carbonates and bicarbonates, or their combinations. Exemplary fluxing agents are borax (sodium borate, Na₂O.2B₂O₃ either in hydrated or anhydrous form), soda ash (Na₂CO₃), caustic soda, potassium hydroxide, a phosphate salt of potassium such as potassium tripolyphosphate, potassium silicate, sodium hexametaphosphate, sodium polyacrylate, and sodium silicates with a weight ratio of SiO₂ to Na₂O of 2.00 to 3.25. The sodium silicates are readily available, easy to mix with hydrous kaolin in slurry form, and require low dosage levels.

The calcined kaolin particles can contain a small amount of active flux cations. For example, the calcined kaolin particles can contain an active flux cation in an amount of less than 2.5%, 2.3% or less, 2.0% or less, 1.9% or less, 1.8% or less, 1.7% or less, 1.6% or less, 1.5% or less, 1.4% or less, 1.2% or less, or 1.0% or less by weight of the calcined kaolin particles. In some embodiments, the calcined kaolin particles can contain an active flux cation in an amount of 0.2% or greater, 0.4% or greater, 0.5% or greater, 0.6% or greater, 0.8% or greater, 1.0 or greater, 1.2% or greater, 1.4% or greater, 1.5% or greater, 1.8% or greater, 2.0% or greater, 2.3% or greater, or 2.5% or greater by weight of the calcined kaolin particles. In some embodiments, the calcined kaolin particles can contain an active flux cation in an amount of from 0.2% to 2.0%, from 0.2% to less than 2.0%, from 0.5% to less than 2.0%, from 1.0% to less than 2%, from 0.5% to 1.8%, from 0.5% to 1.5%, from 0.5% to less than 2.5%, from 1.5% to less than 2.5%, from 0.5% to less than 2.5%, or from 1.5% to less than 2.0%.

The calcined kaolin particles can have a surface area of 10 m²/g or less. For example, the calcined kaolin particle can have a surface area of less than 9 m²/g, 8 m²/g or less, 7 m²/g or less, 6 m²/g or less, or 5 m²/g or less. In some embodiments, the calcined kaolin particles can have a surface area of 2 m²/g or greater, 3 m²/g or greater, 4 m²/g or greater, 5 m²/g or greater, 6 m²/g or greater, 7 m²/g or greater, or 8 m²/g or greater. In some embodiments, the calcined kaolin particles can have a surface area of from 2 m²/g to 10 m²/g, from 3 m²/g to 10 m²/g, from 4 m²/g to 10 m²/g, from 2 m²/g to less than 9 m²/g, from 3 m²/g to less than 9 m²/g, from 4 m²/g to less than 9 m²/g, from 3 m²/g to 6 m²/g, from 3 m²/g to 5 m²/g, from 4.5 m²/g to 10 m²/g, or from 5 m²/g to 9 m²/g. The surface area of the calcined kaolin particles can be determined by a Micromeritics Gemini 2370 surface area analyzer.

The disclosed calcined kaolin particles can have improved (that is, low) oil absorption properties compared to current commercial products. For example, the calcined kaolin particles can have an oil absorption of 65% or less (65 lbs or less oil per 100 lbs particle) by weight of the calcined kaolin particles. For example, the calcined kaolin particles can have an oil absorption of 65% or less, 60% or less, 55% or less, 50% or less, 45% or less, 43% or less, 40% or less, 38% or less, 35% or less, or 30% or less by weight of the calcined kaolin particles. In some embodiments, the calcined kaolin particles can have an oil absorption of 25% or greater, 27% or greater, 28% or greater, 30% or greater, 32% or greater, 35% or greater, or 40% or greater by weight of the calcined kaolin particles. In some embodiments, the calcined kaolin particles can have an oil absorption of from 25% to 65%, from 25% to 60%, from 25% to less than 55%, from 25% to less than 45%, from 35% to 65%, from 35% to 60%, from 45% to 65%, from 45% to 60%, from 27% to 40%, or from 30% to 40% by weight of the kaolin particles. As used herein, oil absorption is determined using ASTM D 281 “Oil Absorption by Spatula Rub-out.” The data are reported in pounds (grams) of oil absorbed per 100 pounds (grams) of calcined kaolin (%).

The calcined kaolin particles can also be characterized by their whiteness, yellowness, and Hunter L, a, and b values. Whiteness, Yellowness, and Hunter L, a, b values are measured using a Technibrite Micro TB-1C brightness meter, manufactured by Technidyne Corporation. In some embodiments, the calcined kaolin particles can have a Hunter b value of 2.5 or less, 2.4 or less, 2.3 or less, 2.2 or less, 2.0 or less, 1.9 or less, 1.8 or less, or 1.7 or less. For example, the calcined kaolin particles can have a Hunter b value of 0.8 or greater, 1.0 or greater, 1.2 or greater, or 1.5 or greater. In some embodiments, the calcined kaolin particles can have a Hunter b value of from 0.2 to 2.5, from 1.2 to 2.5, from 0.2 to 2.0, from 1.0 to 2.0, from 1.2 to 2.0, or from 1.2 to 1.9. The Hunter L value can be from 95 to 98 or from 96 to 98 and the Hunter a value can be from −0.65 to −0.10 or from −0.50 to −0.10.

The calcined kaolin particles can have a Hunter yellowness index of 3.7 or less, 3.6 or less, 3.5 or less, 3.3 or less, 3.0 or less, 2.9 or less, 2.8 or less, or 2.7 or less. In some embodiments, the calcined kaolin particles can have a Hunter yellowness index of 1.5 or greater, 2.0 or greater, 2.5 or greater, or 2.7 or greater. In some embodiments, the calcined kaolin particles can have a Hunter yellowness index of from 1.5 to 3.7, from 1.5 to 3.5, from 1.5 to 3.0, or from 1.5 to 2.9.

The calcined kaolin particles can have a steepness of 21 or greater. For example, the calcined kaolin particle can have a steepness of 22 or greater, 24 or greater, 25 or greater, 26 or greater, 27 or greater, or 28 or greater. In some embodiments, the calcined kaolin particles can have a steepness of 40 or less, such as 38 or less, 37 or less, 36 or less, 35 or less, or 34 or less. In some embodiments, the calcined kaolin particles can have a steepness of from 21 to 38, from 22 to 38, from 24 to 38, or from 22 to 37. The steepness of the particles is obtained from the Sedigraph 5100 measurements using the equation (d30*100/d70), in which the d30 value is the value at which 30% by weight of the particles have an esd less than that d30 value, and the d70 value is the value at which 70% by weight of the particles have an esd less than that d70 value.

The calcined kaolin particles can also contain minerals such as iron oxide, titanium oxide, and silicon oxide. In some embodiments, the calcined kaolin particles can have a Fe₂O₃ content of less than 2% by weight, based on the total weight of the kaolin particles. In some embodiments, the kaolin particles can have a Fe₂O₃ content of 1.5 wt % or less, 0.75% by weight or less, 0.5% by weight or less, 0.4% by weight or less, 0.3% by weight or less, or 0.2% by weight or less, based on the total weight of the calcined kaolin particles. In some embodiments, the calcined kaolin particles can have a Fe₂O₃ content of from greater than 0% to less than 2.0% by weight or from greater than 0% to 1.0% by weight, based on the total weight of the calcined kaolin particles.

The calcined kaolin particles can include less than 3 wt % titania content. For example, the calcined kaolin particles can have a TiO₂ content of 2% by weight or less, 1.8% by weight or less, or 1.5% by weight or less, based on the total weight of the calcined kaolin particles. In some embodiments, the calcined kaolin particles can have a TiO₂ content of from greater than 0% to 2% by weight or from greater than 0% to 1.5% by weight, based on the total weight of the calcined kaolin particles. The iron oxide or titanium oxide content of the kaolin particles can be determined by X-ray fluorescence spectroscopy.

Other materials and/or impurities present in calcined kaolin particles can include alkali materials such as sodium oxide and potassium oxide. The calcined kaolin particles can have an alkali content of less than 3% by weight. For example, the kaolin particles can have an alkali content of 1.0% by weight or less, 0.5% by weight or less, 0.4% by weight or less, 0.3% by weight or less, or 0.2% by weight or less, based on the total weight of the kaolin particles. In some embodiments, the calcined kaolin particles can have a 1(20 content of greater than 0% by weight. For example, the calcined kaolin particles can have an K₂O content of 1% by weight or less, 0.5% by weight or less, 0.4% by weight or less, 0.3% by weight or less, or 0.2% by weight or less, based on the total weight of the calcined kaolin particles. In some embodiments, the calcined kaolin particles can have a Na₂O content of 0% by weight or greater. For example, the calcined kaolin particles can have a Na₂O content of 1% by weight or less, 0.5% by weight or less, 0.4% by weight or less, 0.3% by weight or less, or 0.2% by weight or less, based on the total weight of the calcined kaolin particles.

Crude Kaolin

As described herein, the calcined kaolin particles can be produced by processing a hydrous kaolin crude in the presence of a fluxing agent. The hydrous kaolin crude can be derived from a coarse kaolin crude or a blend of a coarse kaolin crude and fine kaolin crude. The coarse kaolin crude or the blend of coarse and fine kaolin crude can include particles wherein 99% by weight or less (e.g., 98% or less, 97% or less, or 96% or less) have a particle size diameter of less than 10 microns; 98% by weight or less (e.g., 97% or less, 95% or less, 94% or less, 92% or less, or 90% or less) have a particle size diameter of 5 microns or less; 86% by weight or less (e.g., 85% or less, 83% or less, 82% or less, 81% or less, 78% or less, 75% or less, 73% or less, 70% or less, 68% or less, 65% or less, 63% or less, or 60% or less) have a particle size diameter of 2 microns or less; 75% by weight or less (e.g., 73% or less, 72% or less, 70% or less, 68% or less, 65% or less, 63% or less, or 60% or less) have a particle size diameter of 1 micron or less; 60% by weight or less (e.g., 58% or less, 55% or less, 53% or less, 51% or less, 48% or less, or 47% or less) have a particle size diameter of 0.5 micron or less; 50% by weight or less (e.g., 48% or less, 46% or less, 45% or less, 43% or less, 41% or less, or 40% or less) have a particle size diameter of 0.4 micron or less; 40% by weight or less (e.g., 38% or less, 35% or less, 33% or less, or 31% or less) have a particle size diameter of 0.3 micron or less; and 28% by weight or less (e.g., 25% or less, 24% or less, 23% or less, 22% or less, 21% or less, or 20% or less) have a particle size diameter of 0.2 micron or less.

In specific embodiments, the coarse kaolin crude or the blend of coarse kaolin crude and fine kaolin crude contains particles wherein from 60% to 86% by weight (e.g., from 70% to 85%, from 50% to 70% by weight) have a particle size diameter of less than 2 microns. In other embodiments, the coarse kaolin crude or the blend of coarse kaolin crude and fine kaolin crude contains particles wherein 48% to 55% by weight have a particle size diameter of 0.5 microns or less. The surface area of the coarse kaolin crude or the blend of coarse kaolin crude and fine kaolin crude can be 10 m²/g or greater, 12 m²/g or greater, 15 m²/g or greater, such as 16 m²/g or greater, 17 m²/g or greater or 18 m²/g or greater.

In some embodiments, the coarse kaolin crude or the blend of coarse kaolin crude and fine kaolin crude can have an average particle diameter of less than 50 μm, such as 25 μm or less, 10 μm or less, 5μm or less, 2.5 μm or less, 1μm or less, 0.8 μm or less, 0.7 μm or less, 0.6 μm or less, 0.5 μm or less, or 0.4 μm or less, as determined by a Microtrac Model S3500 Particle Size Analyzer. For example, the coarse kaolin crude or the blend of coarse kaolin crude and fine kaolin crude can have an average particle diameter of 0.2 μm or greater, 0.3 μm or greater, 0.4 μm or greater, 0.5 μm or greater, 0.6 μm or greater, 0.7 μm or greater, 0.8 μm or greater, 1.0 μm or greater, 2.5 μm or greater, 5.0 μm or greater, or 10 μm or greater, as determined by a Microtrac Model 53500 Particle Size Analyzer. In some embodiments, the coarse kaolin crude or the blend of coarse kaolin crude and fine kaolin crude can have an average particle diameter of from 0.2 μm to less than 50 μm, from 0.2 μm to 25 μm, from 0.2 μm to 10 μm, from 0.2 μm to 5 μm, from 0.2 μm to 4 μm, from 0.2 μm to 1 μm, from 0.3 μm to 1.0 μm, or from 0.4 μm to 1.0 μm, as determined by a Microtrac Model S3500 Particle Size Analyzer.

Where the kaolin crude includes a blend of coarse kaolin crude and fine kaolin crude, the weight ratio between the coarse kaolin crude and the fine kaolin crude can vary. In some embodiments, the weight ratio between the coarse kaolin crude and the fine kaolin crude can be from 1:1 to 20:1. For example, the weight ratio between the coarse kaolin crude and the fine kaolin crude can be 2:1 or greater, 3:1 or greater, 4:1 or greater, 5:1 or greater, 6:1 or greater, 7:1 or greater, 8:1 or greater, or 9:1 or greater. In some embodiments, the weight ratio between the coarse kaolin crude and the fine kaolin crude can be 20:1 or less, 15:1 or less, 10:1 or less, 9:1 or less, 8:1 or less, 7:1 or less, 6:1 or less, 5:1 or less, 4:1 or less, 3:1 or less, or 2:1 or less. In some embodiments, the weight ratio between the coarse kaolin crude and the fine kaolin crude can be from 1:1 to 20:1, from 2:1 to 20:1, from 1:1 to 10:1, from 2:1 to 10:1, from 2:1 to 8:1, from 2:1 to 7:1, from 1:1 to 5:1, from 1:1 to 3:1, or from 3:1 to 5:1. In certain cases, the blend can include at least 50%, at least 55%, at least 60%, at least 65%, at least 70% or at least 75% by weight of the coarse kaolin crude.

The coarse kaolin crude or the blend of coarse kaolin crude and fine kaolin crude disclosed herein can have a GE brightness (GEB) of 83% or greater. For example, the coarse kaolin crude or the blend of coarse kaolin crude and fine kaolin crude can have a brightness of 85% or greater, 86% or greater, 87% or greater, 88% or greater, or 89% or greater. In some embodiments, the coarse kaolin crude or the blend of coarse kaolin crude and fine kaolin crude can have a brightness of from 83% to 90%, from 85% to 90%, from 86% to 89%, or from 86% to 88%.

Methods of Making

Conventionally, calcined kaolin particles can be produced by calcining a fine fraction of hydrous kaolin in the presence of a fluxing agent to promote particle aggregation during the calcination step. However, the calcined kaolin produced can have significantly broad particle size distribution and do not provide necessary scrub, burnish and stain resistance alongside desired optical properties such as whiteness, brightness, tint strength, gloss and sheen on the paint film. Also, the fluxing agent generally results in a gray color and significant loss in brightness of the calcined kaolin product. This is particularly the case, if an appropriate hydrous kaolin feed is not selected to achieve desirable calcined kaolin properties. Disclosed herein are methods of producing calcined kaolin particles having a high GEB brightness, a narrow particle size distribution, average particle size of 2.5 microns or coarser, low 325 mesh residue levels, and a mullite index (M.I.) of 35 or higher. The methods disclosed herein differs from the prior art in that the right selection of hydrous kaolin feed along with the fluxing agent type and dosage both play a role for obtaining a calcined kaolin product that provides desirable properties.

The calcined kaolin particles can be produced by first dispersing a crude kaolin, then separating the dispersion using one or more of degritting, floatation, ozonation, centrifugation, delamination, selective flocculation, magnetic separation, and then refining in any suitable manner to provide high brightness coarse and/or fine kaolin particles.

In some embodiments, the method can include forming a kaolin slurry by combining the kaolin crude with water, and optionally a dispersant. The dispersant can be added to the slurry to provide additional fluidity to facilitate the subsequent (including degritting) processes. The dispersant can be an organic dispersant or inorganic dispersant. Suitable inorganic dispersants include phosphate and silicate salts. Examples of phosphate salts include inorganic polyphosphates and pyrophosphates (which are actually a type of polyphosphate), sodium hexametaphosphate (SHMP), sodium tripolyphosphate (STPP), tetrasodium pyrophosphate (TSPP), potassium tripolyphosphate (KTPP), potassium silicate, and sodium silicate. Suitable organic dispersants can include ammonia-based dispersants, sulfonate dispersants, carboxylic acid dispersants, and polymeric dispersants (such as polyacrylate dispersants), as well as other organic dispersants conventionally employed in kaolin particle processing. The amount of dispersant used in the slurry can be from 0.01% to 1% based on the weight of kaolin crude.

The method for refining the kaolin crude can include degritting the slurry. Degritting can be performed in any conventional manner using one or more of sieves, sandboxes, gravity settling, or hydrocyclones. Either wet or dry degritting may be employed. In some embodiments, degritting can be carried out by combining the kaolin crude with water and passing the slurried mixture through a sieve, such as a 325 mesh sieve or a 200 mesh sieve. The resulting degritted kaolin crude may be composed largely of kaolin particles that usually have a wide range of sizes ranging from 0.3 microns to 15 microns.

After degritting, the resulting degritted kaolin can be subjected to flotation, selective flocculation, and/or magnetic separation. Flotation, selective flocculation, and/or magnetic separation serve to reduce the titania content of the kaolin crude.

Selective flocculation can be carried out in any conventional manner. In selective flocculation, charged inorganic or organic molecules are used to selectively flocculate minerals from each other based on difference in mineral species. In some embodiments, the flocculation polymer can include a high molecular weight anionic polymer having a molecular weight greater than 100,000 Da. The high molecular weight anionic polymer can be selected from an anionic polyacrylamide, an acrylate acrylamide copolymer, an acrylic acrylamide copolymer, and combinations thereof. The selective flocculation process is such that exclusively gray crudes, or crude blends of various colored kaolin clays can be processed to obtain premium brightness kaolin products.

The method can further include conditioning the kaolin suspension prior to adding the flocculation polymer thereto. The conditioning step can include the addition of various conditioning chemicals to facilitate polymer absorption (a high molecular weight, anionic polymer) onto the impurities in the kaolin clay during the selective flocculation step. Other suitable conditioning steps can include allowing the kaolin suspension to age for a period of at least thirty minutes, adjusting the pH of the kaolin suspension prior to allowing the suspension to age, adding sodium salt to the kaolin suspension after providing the dispersed aqueous suspension, or mechanically agitating the kaolin suspension during the aging.

Flotation can be performed in any conventional manner including wet flotation, ultraflotation, froth flotation, or TREP flotation (titania removal and extraction process). General methods of flotation are described in Mathur, S., “Kaolin Flotation”, Journal of Colloid and Interface Science, 256, pp. 153-158, 2002, which is hereby incorporated by reference in this regard.

The kaolin can be centrifuged prior to flotation, selective flocculation, and/or magnetic separation to control the particle size distribution such that subsequent high speed centrifuge operation results in the desired particle size distribution. Although not wishing to be bound by any theory, it is believed that the usage of high-speed centrifuge can also results in removal of some impurities, such as color impurities and thus increase the brightness of the clay. Centrifugation can be conducted in a single step or multiple steps. In some embodiments, the method can include a high-speed centrifugation treatment in which the centrifuge can operate at “g” forces from above 1,000 to 10,000. For example, the high-speed centrifugation treatment can operate at “g” forces from 2,000 to 7,500 or from 2,500 to 5,000. Examples of centrifuges that can be used in the methods described herein can include Bird solid bowl machines, high speed centrifuges, horizontal three-phase centrifuges, and the like.

The kaolin undergoing processing can be optionally subjected to ozonation or treated with hydrogen peroxide or sodium hypochlorite. Ozonation involves, using ozone, to bleach components, such as organic discolorants, that may be present. The ozone acts not only to destroy substantial portions of discoloring organics, but also destroys by oxidation the organic dispersant, if such a compound is present. However, the ozone does not destroy inorganic dispersants. Ozone, hydrogen peroxide or sodium hypochlorite can be utilized for removing any organic impurities associated with the crude kaolin or introduced during clay processing steps.

Ozonation can be carried out at a suitable dosage level, such as from 0.1 to 20 pounds of ozone per ton of kaolin. In some embodiments, ozonation can be carried out at a dosage level from 0.5 to 10 pounds of ozone per ton of kaolin. The ozone can be applied as a stream of bubbles which can be passed upwardly through the slurry. This can be a batch process or a continuous process in which the ozone bubbles pass counter current to a flow of the slurry in a pipe or other conduit, such as mixed and packed column.

The method of making the calcined kaolin can include subjecting the kaolin to a delamination process, for example, using media grinders such as a Netzsch mill. In some cases, subjecting delaminated coarse crudes and fine crudes in the presence of a fluxing agent can provide a calcined kaolin product having high MI, high brightness, low residue content with good scrub resistance and paint properties.

The kaolin obtained from the one or more of degritting, floatation, ozonation, high speed centrifugation, selective flocculation, and magnetic separation can be further refined. For example, the kaolin can be further refined using a method including at least one of flocculation, bleaching, filtering, drying, blending, and pulverizing to provide the ultrafine hydrous kaolin. Flocculation involves separating minerals of one species from minerals of the same species, e.g., the separation of ultrafine kaolin particles from fine or coarse kaolin particles. Flocculation can be carried out using an ionic material, such as an acid. In some embodiments, sulfuric acid in combination with alum can be used for flocculation.

The methods described herein can include bleaching the kaolin particles. Generally, bleaching includes increasing the brightness of the kaolin. Bleaching can include contacting the kaolin with a suitable amount of one or more of hydrosulfite (dithionite) salts, potassium permanganate, oxygen gas, alkali bichromates, alkali chlorates, alkali chlorites, ammonium persulfate, sodium borohydrite, sodium bisulfate, soluble peroxides such as sodium and hydrogen peroxide, or sodium hypochlorite. Filtration can be employed to increase the solids content of the kaolin sample (e.g. such as to greater than 50 wt %) after bleaching. Increasing the solids content in some instances can improve the efficiency of a subsequent spray drying operation. Filtration can be carried out using rotary drum vacuum filters.

The filter cake of the kaolin particles can be re-dispersed in the presence of one or more of the dispersants described herein. The dispersant chosen can affect various properties of the kaolin clay product formed, such as the brightness and the alkali (e.g. sodium) level, among other properties.

Drying, such as spray drying, the kaolin can be performed to reduce the moisture level of the kaolin. Drying the kaolin may facilitate subsequent pulverization of the kaolin. The kaolin can be dried by spray drying, flash drying, rotary drying, or a combination thereof. The heated air stream can have a temperature of from 600° F. to 1,000° F. In some embodiments, after drying the kaolin can have a moisture level of less than 1.5% by weight, less than 1% by weight, or less than 0.5% by weight.

In the present case, calcination can be carried out after refining the crude kaolin by degritting, floatation, ozonation, high speed centrifugation, selective flocculation, magnetic separation, bleaching, filtering, drying and/or pulverizing to obtain a coarse and/or a fine stream kaolin. In particular, calcination can be carried out on the coarse kaolin or a blend of the coarse and fine kaolin. Calcination can be carried out at a temperature and for a duration of time sufficient to convert hydrous kaolin to spinel and then a targeted percentage of the spinel to mullite. Calcination temperature and residence time are a function of the process configuration utilized. The upper temperature limit for the calcination step is determined by the amount of mullite desired in the finished crystalline lattice.

The hydrous kaolin clay feed to the calciner can be dried and pulverized so that a finely dispersed powder is presented for heat treatment. The hydrous kaolin feed for calcination can be anionically dispersed for beneficiation and spray dried. This is but one of numerous approaches available to one skilled in the art of kaolin calcination. Uniform heating to the requisite temperature minimizes the generation of coarse agglomerates that can mitigate the level of scrubs/burnish resistance of the pigment extender and impact the film forming characteristics of the coating composition. The calcined kaolin particles are therefore pulverized to a finely dispersed powder after calcination.

As disclosed herein, fluxing agents are added to the hydrous kaolin slurry prior to calcination. The dosage of the fluxing agent and the type of fluxing agent required are dependent on the hydrous kaolin feed morphology and its particle size distribution. The fluxing agent may be mixed with kaolin in the presence of water at various points during the beneficiation of hydrous kaolin. Thus, the fluxing agent may be added during or after formation of a kaolin slurry. If added during slurry formation, the fluxing agent can act as a dispersing agent to improve kaolin dispersion. It is preferable to add the fluxing agent to the dispersed hydrous kaolin slurry just prior to spray drying. Once dried, the calciner feed can be pulverized and then calcined at temperatures between 1050 to 1300° C. (1922 to 2372° F.), preferably from about 2115° F. to 2220° F. The calcination temperature and process time is dictated by the desired level of product M.I. The calciner feed can be calcined for about 60 minutes.

The methods described herein can include pulverizing the kaolin particles. In some embodiments, the kaolin particles can be pulverized during or after spray drying and/or during or after calcination. For example, rotating paddles and baffles present in the air dryer/oven can beat and flop the airborne kaolin around within the dryer/oven such that, as the kaolin dries/calcines, it becomes pulverized. Pulverization may break up agglomerates formed during drying, calcination, and other process acts. In some embodiments, the kaolin particles can be pulverized at least once.

The pulverized kaolin particles, once they are sufficiently dried/calcined and sufficiently sized, become entrained in the air stream and can be removed from the dryer/oven for subsequent separation. In some embodiments, the individual kaolin particles leaving the dryer/oven may be separated into respective product streams by particle size via one or more conventional classification techniques. Such techniques can include an air cyclone or an air classifier. After classification, coarse calcined kaolin and fine calcined kaolin can be obtained. The fine calcined kaolin particles can have lower levels of +325 mesh residue level and crystalline silica content, as described herein, than the coarse calcined kaolin. For example, the coarse calcined kaolin can have a +325 mesh residue level of 0.5% or greater (for example, 1% or greater, 2% or greater, 2.5% or greater, from 0.5% to 5% by weight or from 1% to 5% by weight) and a crystalline silica content of 0.5% by weight or less.

Methods of Use

The calcined kaolin particles can be advantageously employed in several applications wherein calcined kaolin particles can be used. For example, the calcined kaolin particles can be used in compositions such as in coatings. The coating compositions can be used for several applications, including industrial coatings (e.g., automotive coatings and architectural coatings), as abrasive or a refractory material particularly in investment casting applications due to its high hardness, high mullite content, and refractory property, inks, films, adhesives, and paints. In some embodiments, the coatings can be used in paint compositions, such as a high gloss, semi-gloss, or flat paint. The calcined kaolin particles disclosed herein can also be used in road construction (road paints), in ceramics (tile) and in laminate countertops.

In some embodiments, the calcined kaolin particles can be used in adhesives. The calcined kaolin particles can also be used in plastics, papers such as thermal paper, or as a filler. The calcined kaolin particles can also be used in other applications, such as in the making of activated alumina, highly reactive metakaolin, absorbent, catalyst, alum, or in agriculture applications. It should be noted that the methods of preparing the calcined kaolin particles disclosed herein may not include all the processing steps described herein. For example, calcined kaolin particles can be prepared from coarse fractions generated from the centrifugation step. In particular, the coarse fractions generated from the centrifugation step can be further processed via additional processing such as using magnetic separation followed by delamination to obtain a wide range of high aspect ratio products that are used as the filler/extender in tire or rubber applications, and such the like.

When used in coatings, the calcined kaolin particles can provide improved scrub resistance, for example, of at least 1400 cycles, at least 1800 cycles, or from 1400 cycles to 2200 cycles) as determined by ASTM D2486-06, after curing. In some embodiments, the calcined kaolin particles can provide improved stain resistance when used in coatings. In some embodiments, the coatings can exhibit an improved stain resistance to lipstick, washable marker, and highlighter stains, compared to an identical formulation comprising calcined kaolin having a particle size steepness of less than 21, such as from 15 to 20, preferably 20. In some embodiments, the cured formulations can exhibit an initial (unscrubbed) gloss at 85° of less than 3 and an increase in gloss at 85° of no more than 5 gloss units after scrubbing, as determined by ASTM D2457 using a BYK micro-tri-gloss meter. In some embodiments, the cured formulations can exhibit an improved brightness (e.g., up to 2% such as from 1 to 1.7% increase in brightness), compared to an identical formulation comprising calcined kaolin having a particle size steepness of less than 21, such as from 15 to 20, preferably 20. In some embodiments, the cured formulations can exhibit an improved whiteness (e.g., up to 3% such as from 1.5 to 3% increase in whiteness), compared to an identical formulation comprising calcined kaolin having a particle size steepness of less than 21, such as from 15 to 20, preferably 20. In some embodiments, the cured formulations can exhibit a decreased yellowness (e.g., up to 1 unit such as from 0.5 to 0.6 units or up to 30% such as from 15 to 30% decrease in yellowness), compared to an identical formulation comprising calcined kaolin having a particle size steepness of less than 21, such as from 15 to 20, preferably 20. In some embodiments, the cured formulations can exhibit a decreased sheen at 85 degrees (e.g., up to 20% such as from 5 to 20% % decrease in sheen at 85 degrees), compared to an identical formulation comprising calcined kaolin having a particle size steepness of less than 21, such as from 15 to 20, preferably 20. The steepness of the calcined particles disclosed herein is in the range from 21 to 38, whereas the steepness of a control sample (as described in the examples) is 20.

By way of non-limiting illustration, examples of certain embodiments of the present disclosure are given below.

### EXAMPLES

The following examples are put forth so as to provide those of ordinary skill in the art with a complete disclosure and description of how the compositions and/or methods claimed herein are made and evaluated, and are intended to be purely exemplary and are not intended to limit the scope of the disclosure. Unless indicated otherwise, parts are parts by weight, temperature is in ° C. or is at ambient temperature, and pressure is at or near atmospheric.

### Example 1

### Calcined Kaolin Pigment as Paint Extender

Kaolin samples obtained from Middle Georgia mineral deposits were processed to provide feed kaolin samples as described in Table 1.

TABLE 1
Properties of feed material

| | 100% | 75% Coarse/ | |
|---|---|---|---|
| | Coarse | 25% Fine | 100% |
| Properties | Feed | Blend Feed | Fine Feed |
| TAPPI Brightness (%) | 89.9 | 88.3 | 83.5 |
| ISO Brightness (%) | 88.6 | 87.0 | 82.2 |
| Hunter Yellowness | 4.3 | 4.6 | 5.3 |
| Hunter | | | |
| L | 96.1 | 95.7 | 94.7 |
| a | −0.30 | −0.25 | −0.08 |
| b | 2.90 | 3.04 | 3.46 |
| pH | 6.8 | 8.0 | 10.0 |
| Residue (%), +325 | 0.0023 | 0.0024 | 0.0026 |
| mesh | | | |
| Surface Area (m²/g) | 17.0 | 18.6 | 23.2 |
| PSD | | | |
| % < 10 μm | 99 | 99 | 100 |
| % < 5 μm | 96 | 97 | 99 |
| % < 2 μm | 81 | 85 | 97 |
| % < 1 μm | 66 | 72 | 90 |
| % < 0.5 μm | 48 | 55 | 76 |
| % < 0.4 μm | 41 | 48 | 68 |
| % < 0.3 μm | 33 | 38 | 55 |
| % < 0.2 μm | 21 | 25 | 37 |
| median, μm | 0.55 | 0.48 | 0.27 |
| TiO₂ (%) | 1.02 | 1.14 | 1.48 |
| Fe₂O₃ (%) | 0.32 | 0.44 | 0.81 |

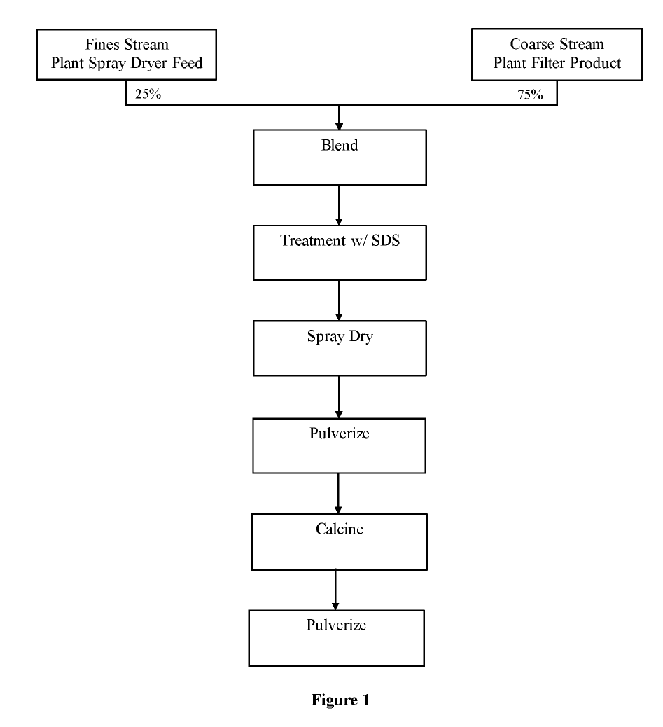

The feed kaolin samples were refined, for example, as shown in FIG. 1. Briefly, calcined kaolins samples, Samples 1 and 2, were prepared by blending the “coarse” hydrous kaolin feed stream as obtained from the BASF manufacturing facility and a “fine” hydrous kaolin feed stream at 75%/25% ratio followed by surface treatment to obtain a “blend” feed stream for producing inventive calcined kaolin products. The blend of coarse and fine feed streams at 75%/25% ratio had a Sedigraph particle size of 80-85%<2 micron. For the Samples 1 and 2, sodium silicate (SDS) fluxing agent was used for the surface treatment.

The surface treated feed with fluxing agent was spray dried using a lab spray dryer. The dried material was then pulverized using a Micro pulverizer equipped with a 0.020″ screen and then calcined in a laboratory muffle furnace at 1,125° C. (i.e., 2,115° F.) for a 60 minute soak time. The resulting calcined kaolin product was then pulverized using a Micro pulverizer equipped with 0.020″ screen. In this example, the calciner feed was pulverized five times and the calciner product was pulverized three times.

Sample 3 was prepared using only “coarse” kaolin feed stream. In particular, Sample 3 was prepared by treating coarse stream filter product with SDS followed by spray drying. The spray dried material was then pulverized using a Micro pulverizer equipped with a 0.020″ screen and then calcined in a laboratory muffle furnace at 1,125° C. (i.e., 2,115° F.) for a 60 minute soak time. The resulting calcined kaolin product was then pulverized using the Micro pulverizer equipped with 0.020″ screen.

Table 2 gives the data for the calcined kaolin products prepared according to the present disclosure and a comparative commercially available calcined kaolin. The commercially available calcined kaolin (also referred to herein as “control” kaolin) is produced from a chemically dispersed blunged/degritted hydrous kaolin crude feedstock that is subject to a classification step and a beneficiation step followed by surface treatment using a sodium silicate (SDS) fluxing agent to obtain a feedstream before calcination. The control kaolin feed stream has about 88-90%<1 micron particle size, as measured by Sedigraph 5100 particle size analyzer (Micromeritics Corporation, USA). This is referred to as the “fine” feed stream.

TABLE 2
Properties of calcined kaolin products

| | | | | Current |
|---|---|---|---|---|
| Properties | 75% Coarse/25% Fines | | 100% Coarse | Production |
| Sample ID | Sample 1 | Sample 2 | Sample 3 | Control Sample |
| Calcining | 2,115 | 2,115 | 2,220 | |
| Temperature, ° F. | | | | |
| Calcine Time, min | 60 | 60 | 60 | |
| Brightness, GEB | 93.0 | 92.0 | 94.1 | 89.5 |
| Mullite Content, % | 50 | 51 | 51 | 46.4 |
| 325 Residue, % | 0.1438 | 0.1783 | 0.0782 | 0.180 |
| Brightness, ISO | 91.3 | 89.9 | 92.0 | 87.6 |
| L* | 97.62 | 97.04 | 97.88 | 95.78 |
| a* | −0.30 | −0.40 | −0.42 | −0.65 |
| b* | 1.88 | 1.89 | 1.81 | 3.28 |
| ASTM Yellowness | 3.34 | 3.30 | 3.11 | 5.64 |
| Hunter Yellowness | 2.85 | 2.88 | 2.74 | 4.89 |
| Sedigraph Particle | | | | |
| Size | | | | |
| % < 10.0 μm | 87 | 75 | 84 | 80 |
| % < 5.0 μm | 71 | 59 | 75 | 65 |
| % < 2.0 μm | 40 | 35 | 39 | 45 |
| % < 1.0 μm | 16 | 15 | 15 | 22 |
| Average Particle | 2.7 | 3.6 | 2.9 | 2.5 |
| Size, μm | | | | |

As shown in Table 2, Samples 1 through 3 have significantly higher GE brightness, coarser/narrower particle size distribution, and higher average particle size (d₅₀) than the control sample. In addition, the +325 mesh residue is similar or lower than control sample, which is a desirable property for paint applications.

The data further confirm that as a result of using a coarse stream in the calciner feed blend or using exclusively coarse feed stream, calcined kaolin products with coarser and steeper particle size distribution can be obtained. Also use of coarse stream, significantly improved the calcined product brightness. In each one of the exemplified calcined products, a M.I. target of 50 was achieved. This was accomplished without forming significant amount of +325 mesh residue in the final calcined product.

The exemplified calcined kaolin pigments were used in paint formulations. Paint results are presented in Table 3. As shown, whiteness, brightness and yellowness are significantly improved on paint when using the exemplified calcined product as the extender compared to the control sample. Gloss values were similar. Interestingly, there is some reduction on sheen value on Sample 2 compared to the control (2.1 vs. 2.6). Such low sheen value could be advantageous for flat paints.

An important advantage of Sample 2 over control sample include improvements on color properties (lower sheen, better whiteness, brightness and yellowness) are not sacrificed with improved scrub resistance. Sample 2 provides 13% improvement in scrub resistance. Such an improvement in scrub resistance is likely achieved as a result of coarser/narrower particle size distribution (45%<2 microns on control sample vs. 35%<2 microns on Sample 2) and larger average particle size (d₅₀ is 2.5 microns on control sample and 3.6 microns on Sample 2).

TABLE 3
Properties of paint prepared from calcined kaolin pigments

| Properties | Control | Sample 2 |
|---|---|---|
| Viscosity, KU | 104 | 101 |
| Contrast Ratio 3 mils: | 98.1 | 97.6 |
| Brightness: | 88.01 | 89.03 |
| Whiteness: | 80.66 | 82.91 |
| Yellowness: | 2.50 | 2.04 |
| L* | 96.04 | 96.29 |
| a* | −0.70 | −0.74 |
| b* | 2.01 | 1.74 |
| Gloss @ 20 deg: | 1.4 | 1.4 |
| Gloss @ 60 deg: | 2.6 | 2.7 |
| Sheen @ 85 deg: | 2.6 | 2.1 |
| Tint Strength: Xrite | 100.0 | 95.3 |
| Scrub Resistance: 1 day Air | 1863 | 2108 |
| Cure then 2.0 Hr. 50 C. cure | | |
| % Change | | 13.1 |
| Unscrubbed gloss 60°, 85° | 2.4 2.6 | 2.5 2.1 |
| Scrubbed gloss 60°, 85° | 3.1 5.7 | 3.0 4.6 |
| Scrubbed Difference Result: | 0.7 3.1 | 0.5 2.5 |
| Ability to Filter: | OK | OK |

This example provides a novel and unique calcined kaolin with a premium brightness; very coarse/steep particle size distribution and very high mullite index that is believed not achieved before. The exemplified calcined kaolin can be obtained by selecting a suitable hydrous kaolin feed stream and treating such feed stream with a fluxing agent (sodium disilicate, SDS) which promotes particle aggregation during calcining step. The exemplified calcined kaolin pigment extender can be advantageously used in paints to improve optical properties such as brightness, whiteness, opacity and gloss/sheen control, at the same time provides superior scrub and, burnish resistance of the paint.

### Example 2

### Calcined Kaolin Pigment as Paint Extender

Feed kaolin samples were processed to provide calcined kaolin as described in Table 4.

TABLE 4
Properties of feed material and calcined kaolin product

| | | | | Current |
|---|---|---|---|---|
| | Blend of Delaminated Coarse/ | | | Production |
| Properties | Fines Streams | | | Control |
| Sample ID | Sample 4 | Sample 5 | Sample 6 | Sample |
| Delam Coarse/Fines | 55/45 | 75/25 | 55/45 | |
| Stream Ratio | | | | |
| Calcine Feed | 86.5 | 87.1 | 86.1 | 83.5 |
| Brightness, GEB | | | | |
| Calcine Feed | 60 | 86 | 63 | 97 |
| Sedigraph PSD, | | | | |
| % < 2.0 μm | | | | |
| Calcine | 2,150 | 2,150 | 2,150 | |
| Temperature, ° F. | | | | |
| Calcine Time, min | 60 | 60 | 60 | |
| Brightness, GEB | 90.9 | 92.6 | 90.0 | 89.5 |
| Brightness, ISO | 89.4 | 91.6 | 88.5 | 87.6 |
| L* | 95.89 | 97.02 | 95.54 | 95.78 |
| a* | −0.46 | −0.47 | −0.64 | −0.65 |
| b* | 2.04 | 1.98 | 2.46 | 3.28 |
| Hunter Yellowness | 3.12 | 2.92 | 3.67 | 4.89 |
| Mullite Content, % | 50.9 | 51.2 | 46.0 | 46.4 |
| 325 Residue, % | 0.03 | 0.03 | 0.10 | 0.180 |
| Surface Area, m²/g | 3.8 | 4.0 | 3.3 | |
| Oil Absorption, % | 55 | 59 | 60 | |
| Sedigraph Particle | | | | |
| Size | | | | |
| % < 10.0 μm | 90 | 89 | 79 | 80 |
| % < 5.0 μm | 64 | 72 | 54 | 65 |
| % < 2.0 μm | 28 | 40 | 24 | 45 |
| % < 1.0 μm | 11 | 16 | 9 | 22 |
| Sedigraph Average | 3.7 | 2.6 | 4.5 | 2.5 |
| Particle Size, μm | | | | |
| Microtrac Particle | | | | |
| Size | | | | |
| D90, μm | 17.4 | 13.4 | 20.0 | 20.0 |
| D50, μm | 7.5 | 4.8 | 8.1 | 4.8 |
| D10, μm | 3.0 | 1.8 | 3.0 | 1.6 |

As shown in Table 4, Samples 4 through 6 have higher GE brightness, coarser/narrower particle size distribution, and higher average particle size (d₅₀) than the control sample. In addition, the +325 mesh residue is significantly lower than the control sample, which is a desirable property for paint applications.

The data further confirm that as a result of using a blend of coarse and fine streams in the calciner feed, calcined kaolin products with coarser and steeper particle size distribution can be obtained.

The exemplified calcined kaolin pigments were used in paint formulations. Paint results are presented in Table 5. As shown, whiteness, brightness and yellowness are significantly improved on paint when using the exemplified calcined product as the extender compared to the control sample.

TABLE 5
Properties of paint prepared from calcined kaolin pigments

| Properties | Control | Sample 4 | Sample 5 |
|---|---|---|---|
| Viscosity, KU | 103 | 101 | 100 |
| Contrast Ratio 3 mils: | 98.3 | 97.8 | 97.8 |
| Brightness: | 88.34 | 88.95 | 89.30 |
| Whiteness: | 81.84 | 83.92 | 84.34 |
| Yellowness: | 2.19 | 1.65 | 1.62 |
| L* | 96.06 | 96.13 | 96.26 |
| a* | −0.84 | −0.85 | −0.86 |
| b* | 1.82 | 1.48 | 1.47 |
| Gloss @ 20 deg: | 1.3 | 1.3 | 1.3 |
| Gloss @ 60 deg: | 2.4 | 2.5 | 2.4 |
| Sheen @ 85 deg: | 2.7 | 2.9 | 3.1 |
| Tint Strength: Xrite | 100.0 | 94.7 | 94.3 |
| Scrub Resistance: 1 day | 1678 | 1689 | 1660 |
| Air Cure then 2.0 Hr. | | | |
| 50 C. cure | | | |
| % Change | | 0.7 | −1.1 |
| Unscrubbed gloss 60°, 85° | 2.4 2.9 | 2.5 3.2 | 2.4 3.3 |
| Scrubbed gloss 60°, 85° | 3.6 7.0 | 3.1 6.4 | 3.2 7.2 |
| Scrubbed Difference | 1.2 4.1 | 0.6 3.2 | 0.8 3.9 |
| Result: | | | |
| Ability to Filter: | OK | OK | OK |

The paint formulations of Table 5 were tested according to the stain resistance test below.

Samples of the paint formulations of Samples 4 and 5 and the control were drawn down to be tested side-by-side using the 7 mil blade of a Dow Film Caster lengthwise on a vinyl scrub chart.

All panels were air dried for approximately 7 days under a temperature of 25° C. (77° F.) and 50% of relative humidity.

The required stains (lipstick, black washable marker, black pen, highlighter, mustard, ketchup, coffee and grape juice stains) were applied perpendicular to that of test paint approximately equal in width (a template with spacers is generally used).

The staining media was left on the coating for approximately 1 hour.

The panels were rinsed with water under the tap thoroughly to remove excess stain (and blot dried if necessary).

The glass panels were turned so that the smooth side is up. Then, the test panels were placed in the scrub machine tray on top of the glass and secure.

The sponge and holder were prepared by rinsing the sponge under running water until saturated and the sponge was squeezed to remove any excess water.

With a syringe, approximately 10 CC of Leneta SC-1 (Standardized Scrub Medium Non-Abrasive type) were measured and the medium was placed on the sponge, run for 25 cycles.

After 25 cycles, it was stopped. The sponge was flipped to the other side, another 5 cc of SC-1 were added and it was run for another 25 cycles. Note: it is permissible to reuse sponges if they are not excessively soiled or damaged.

The test panels were removed, rinsed with water and blot dried.

Each applied stain was then rated visually versus the control.

The results of the test are depicted in Table 6 below.

TABLE 6
Stain resistance

| Stain Resistance | | | |
|---|---|---|---|
| vs. CTL | CTL | Sample 4 | Sample 5 |
| Lipstick | CTL | much better | slight better |
| Black Washable | CTL | much better | better |
| Marker | | | |
| Pen-Black | CTL | = | = |
| Highlighter | CTL | better | slight better |
| Mustard | CTL | = | = |
| Coffee | CTL | = | = |
| Grape Juice | CTL | = | = |

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative materials and method steps disclosed herein are specifically described, other combinations of the materials and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated.

What is claimed is:

1. A calcined kaolin comprising particles and a fluxing agent, wherein the calcined kaolin has a particle size distribution, as measured by a Sedigraph 5100 Particle Size Analyzer, comprising:
90% or less by weight of the particles having a diameter of less than 10 microns;
80% or less by weight of the particles having a diameter of less than 5 microns;
40% or less by weight of the particles having a diameter of less than 2 microns; and
20% or less by weight of the particles having a diameter of less than 1 micron, wherein the calcined kaolin has a GE brightness of 90 or greater, a mullite index of 35 or greater, an average surface area of 2 m²/g or greater, and a particle size steepness of 21 or greater.

2. The calcined kaolin of claim 1, wherein the calcined kaolin has a particle size distribution comprising:
75% or less by weight of the particles having a diameter of less than 10 microns;
60% or less by weight of the particles having a diameter of less than 5 microns;
35% or less by weight of the particles having a diameter of less than 2 microns; and
15% or less by weight of the particles having a diameter of less than 1 micron.

3. The calcined kaolin of claim 1, wherein the calcined kaolin has an average particle size of from 2.5 to 15 microns.

4. The calcined kaolin of claim 1, wherein the calcined kaolin has a GE brightness of from 90 to 96.

5. The calcined kaolin of claim 1, wherein the calcined kaolin has a mullite index of from 45 to 65.

6. The calcined kaolin of claim 1, wherein the calcined kaolin has a +325 mesh residue content of less than 0.15% by weight of the calcined kaolin.

7. The calcined kaolin of claim 1, wherein the calcined kaolin has a steepness of from 21 to 38.

8. The calcined kaolin of claim 1, wherein the fluxing agent is present in an amount of from 1.5% to less than 2.5% by weight of the calcined kaolin.

9. The calcined kaolin of claim 1, wherein the calcined kaolin has an average surface area of from 2 m²/g to 10 m²/g, as determined by Micromeritics Gemini 2370 surface area analyzer.

10. The calcined kaolin of claim 1, wherein the calcined kaolin has an oil absorption of from 45% to 65% by weight.

11. The calcined kaolin of claim 1, wherein the calcined kaolin has a Hunter yellowness index of from 1.5 to 3.0, as determined by Technibrite Micro TB-1C brightness meter.

12. A method of processing a coarse kaolin having a median particle size diameter (d50) of at least 0.40 microns, as measured by a Sedigraph 5100 Particle Size Analyzer, the method comprising:
a) optionally blending the coarse kaolin with a fine kaolin in a weight ratio of from 1:1 to 20:1 to form a blend;
b) surface treating the coarse kaolin or the blend with a fluxing agent to obtain a treated kaolin, wherein the fluxing agent is present in an amount of 1.9% or less by weight of the coarse kaolin or the blend;
c) calcining the treated kaolin to obtain a calcined kaolin; and
d) refining the calcined kaolin to obtain a calcined product,
wherein the calcined product has a GE brightness of 90 or greater, a mullite index of 35 or greater, and a particle size distribution comprising 90% or less by weight of particles having a diameter of less than 10 microns; 80% or less by weight of particles having a diameter of less than 5 microns; 40% or less by weight of particles having a diameter of less than 2 microns; and 20% or less by weight of particles having a diameter of less than 1 micron.

13. The method of claim 12, wherein the coarse kaolin has a particle size distribution comprising
99% or greater by weight of particles having a diameter of less than 10 microns;
96% or greater by weight of particles having a diameter of less than 5 microns;
81% or greater by weight of particles having a diameter of less than 2 microns; and
48% or greater by weight of particles having a diameter of less than 0.5 microns.

14. The method of claim 12, comprising step a) blending the coarse kaolin with a fine kaolin to form a blend.

15. The method of claim 14, wherein the blend comprises a weight ratio of coarse kaolin to fine kaolin of from 3:1 to 5:1.

16. The method of claim 14, wherein the blend has a particle size distribution comprising
99% or greater by weight of particles having a diameter of less than 10 microns;
97% or greater by weight of particles having a diameter of less than 5 microns;
85% or greater by weight of particles having a diameter of less than 2 microns; and
55% or greater by weight of particles having a diameter of less than 0.5 microns.

17. The method of claim 12, wherein the fluxing agent is present in an amount of from 1.5% to 1.9% by weight of the coarse kaolin or the blend.

18. A coarse calcined kaolin obtained from the method of claim 12, having a +325 mesh residue level of from 0.5% to 5% by weight and a crystalline silica content of 0.5% by weight or less.

19. A coating composition comprising the calcined kaolin of claim 1.

20. The composition of claim 19, wherein the composition after application to a substrate as a coating and after curing exhibits a scrub resistance of at least 1400 cycles, as determined by ASTM D2486-06.

21. The composition of claim 19, wherein the composition after application to a substrate as a coating and after curing, the cured composition exhibits an initial (unscrubbed) gloss at 85° of less than 3 and an increase in gloss at 85° of no more than 5 gloss units after scrubbing, as determined by ASTM D2457 using a BYK micro-tri-gloss meter.
